(19) United States
(12) Patent Application Publication
(10) Pub. No.: US 2018/0169447 A1
(43) Pub. Date: Jun. 21, 2018

(54) RESPIRATOR THAT HAS INWARD NOSE REGION FOLD WITH HIGH LEVEL CONFORMATION

(71) Applicant: 3M Innovative Properties Company, St. Paul, MN (US)

(72) Inventors: Philip D. Eitzman, Lake Elmo, MN (US); Dean R. Duffy, Woodbury, MN (US)

(21) Appl. No.: 15/899,143

(22) Filed: Feb. 19, 2018

Related U.S. Application Data
(63) Continuation of application No. 12/823,259, filed on Jun. 25, 2010, now abandoned.

(51) Int. Cl. A62B 18/02; A62B 23/02; A41D 13/11

(52) U.S. Cl. CPC A62B 18/025; A41D 13/1123; A62B 23/025

(57) ABSTRACT

A flat fold filtering face piece respirator 10 that includes a mask body 12 and a harness 14. The mask body 12 includes a filtering structure 16 that contains a cover web 48, 50 and a filtration layer 52 that contains electrically-charged microfibers. The filtering structure 16 is folded over upon itself in a nose region 32 of the mask body 12 to be at least 1 centimeter or more wide and to extend across the upper perimeter of the mask body in a generally straight line when the respirator is in the folded condition. The filtering structure 16 has a deflection greater than about 0.5 millimeters and has a recoverability of at least 40% in the folded condition. A mask body having this construction is beneficial in that it does not need to use a nose foam to obtain a snug fit over the nose.

The present invention pertains to a flat fold filtering face piece respirator that achieves a snug fit in the nose region without the use of a nose foam. The mask body is folded over in the nose region and has layer(s) that together provide sufficient compressibility and recoverability to allow the snug fit to be achieved.

### BACKGROUND

Filtering face piece respirators (sometimes referred to as “filtering face masks” or simply “filtering face pieces”) are generally worn over the breathing passages of a person for two common purposes: (1) to prevent impurities or contaminants from entering the wearer's respiratory system; and (2) to protect other persons or things from being exposed to pathogens and other contaminants exhaled by the wearer. In the first situation, the respirator is worn in an environment where the air contains particles that are harmful to the wearer, for example, in an auto body shop. In the second situation, the respirator is worn in an environment where there is risk of contamination to other persons or things, for example, in an operating room or clean room.

To meet either of these purposes, the mask body of the respirator must be able to maintain a snug fit to the wearer's face. Known mask bodies can, for the most part, match the contour of a person's face over the cheeks and chin. In the nose region, however, there is a complex change in contour, which makes a snug fit more difficult to achieve. The failure to obtain a snug fit can be problematic in that air can enter or exit the respirator interior without passing through the filter media. When this happens, contaminants may enter the wearer's breathing track, or other persons or things may become exposed to contaminants exhaled by the wearer. In addition, a wearer's eyeglasses can become fogged when the exhalate escapes from the respirator interior over the nose region. Fogged eyewear, of course, makes visibility more troublesome to the wearer and creates unsafe conditions for the wearer and others.

Nose foams have been used on respirators to assist in achieving a snug fit over the wearer's nose. Nose foams also are used to improve wearer comfort. Conventional nose foams are typically in the form of compressible strips of foam—see, for example, U.S. Pat. Nos. 6,923,182, 5,765,556, and U.S. Published Application 2005/0211251. Known nose foams have been designed to be wider on each side of a central portion—see, for example, U.S. Pat. Nos. 3,974,829 and 4,037,593. Nose foams also have been used in conjunction with a conformable nose clip to obtain the snug fit—see, for example, U.S. Pat. Nos. 5,558,089, 5,307,796, 4,600,002, 3,603,315, and Des. 412,573 and British Patent GB 2,103,491.

Although known nose foams are able to help provide a snug fit over the wearer's nose, the use of a nose foam on a respirator requires the manufacture of an additional part and an additional processing step to place the part in the proper location on the mask body. The need for further parts and processing steps adds to respirator manufacturing costs.

### SUMMARY OF THE INVENTION

The present invention provides a new flat fold filtering face piece. The respirator comprises a harness and a mask body where the mask body contains a filtering structure that includes a cover web and a filtration layer. The filtration layer contains electrically-charged microfibers. The filtering structure is folded over upon itself in a nose region of the mask body to have a width W of at least 1 centimeter wide and to extend across the upper perimeter of the mask body in a generally straight line. The folded filtering structure has a deflection of greater than 0.5 millimeters (mm) and has a recoverability of at least 40% in the nose region when tested according to the Deflection and Percent Recoverability Test set forth below.

The present invention is beneficial in that it allows a snug fit to be achieved in the nose region of the respirator without having to attach a nose foam to this region of the mask body. Applicants discovered that when the mask body itself is folded over and the proper combination of cover web(s) and filtration layer(s) are used so that the folded structure has the deflection greater than 0.5 mm and a recoverability of at least 40% in the nose region, that sufficient sealing may be achieved over the nose without the use of a nose foam. A filtering structure that has these characteristics when folded can enable the mask body to meet governmental performance requirements.

### Glossary

The terms set forth below will have the meanings as defined:

“aerosol” means a gas that contains suspended particles in solid and/or liquid form;

“central portion” is the central part of the nose foam that extends over the bridge or top of a wearer's nose;

“clean air” means a volume of atmospheric ambient air that has been filtered to remove contaminants;

“comprises (or comprising)” means its definition as is standard in patent terminology, being an open-ended term that is generally synonymous with “includes”, “having”, or “containing” Although “comprises”, “includes”, “having”, and “containing” and variations thereof are commonly-used, open-ended terms, this invention also may be described using narrower terms such as “consists essentially of”, which is semi open-ended term in that it excludes only those things or elements that would have a deleterious effect on the performance of the respirator in serving its intended function;

“contaminants” means particles (including dusts, mists, and fumes) and/or other substances that generally may not be considered to be particles (e.g., organic vapors, et cetera) but which may be suspended in air, including air in an exhale flow stream;

“compressible” means that a noticeable reduction in volume can be detected in response to a pressure or force placed thereupon;

“crosswise dimension” is the dimension that extends across a wearer's nose when the respirator is worn; it is synonymous with the “lengthwise” dimension of the fold in the mask body;

“exhalation valve” means a valve that has been designed for use on a respirator to open unidirectionally in response to pressure or force from exhaled air;

“exhaled air” means air that is exhaled by a respirator wearer;

“exterior gas space” means the ambient atmospheric gas space into which exhaled gas enters after passing through and beyond the mask body and/or exhalation valve;

“exterior surface” means that the surface that is located on the exterior;

“filter media” means an air-permeable structure that is designed to remove contaminants from air that passes through it;

“filtering face piece” means that the mask body itself filters air, as opposed to use of attachable filter cartridges for this purpose;

“flat fold” means that the respirator can be folded flat for storage and opened for use;

“harness” means a structure or combination of parts that assists in supporting the mask body on a wearer's face;

“integral” means made at the same time as;

“interior gas space” means the space between a mask body and a person's face;

“interior surface” means the surface that is located on the inside;

“lengthwise dimension” means the direction of the length (long axis) of the fold (which extends across the bridge of the wearer's nose when the mask is worn);

“mask body” means an air-permeable structure that can fit at least over the nose and mouth of a person and that helps define an interior gas space separated from an exterior gas space;

“memory” means that the deformed part has a tendency to return to its preexisting shape after deforming forces have ceased;

“nose clip” means a mechanical device (other than a nose foam), which device is adapted for use on a mask body to improve the seal at least around a wearer's nose;

“nose foam” means a porous material that is non-integral to the filtering structure of the mask body and that is adapted for placement on the interior of a mask body to improve fit and/or wearer comfort over the nose when the respirator is worn;

“nose region” means the portion of the mask body that resides over a person's nose when the respirator is worn;

“particles” means any liquid and/or solid substance that is capable of being suspended in air, for example, dusts, mists, fumes, pathogens, bacteria, viruses, mucous, saliva, blood, etc.;

“polymer” means a material that contains repeating chemical units, regularly or irregularly arranged;

“polymeric” and “plastic” each mean a material that mainly includes one or more polymers and may contain other ingredients as well;

“porous” means a mixture of a volume of solid material and a volume of voids;

“portion” means part of a larger thing;

“respirator” means a device that is worn by a person to filter air before the air enters the person's respiratory system;

“snug fit” or “fit snugly” means that an essentially air-tight (or substantially leak-free) fit is provided (between the mask body and the wearer's face);

“transverse dimension” means the dimension that extends at a right angle to the lengthwise dimension.

### BRIEF DESCRIPTION OF THE DRAWINGS

FIG. 1 is a partially broken perspective rear view of a flat fold filtering face piece respirator 10, showing the nose region 32 in cross-section, in accordance with the present invention;

FIG. 2 is a partially broken left side view of the respirator 10 shown in FIG. 1;

FIG. 3 is a partially broken bottom view of the respirator 10 in a folded condition;

FIG. 4 is a cross-sectional view of an alternative embodiment of a fold 44 in the nose region of the mask body in accordance with the present invention;

FIG. 5 is a cross-section of an example of a filtering structure 16 that may be used in connection with the present invention; and

FIG. 6 is an example of a pressure/distance curve generated for inventive and comparative samples described in the Example section.

### DETAILED DESCRIPTION OF PREFERRED EMBODIMENTS

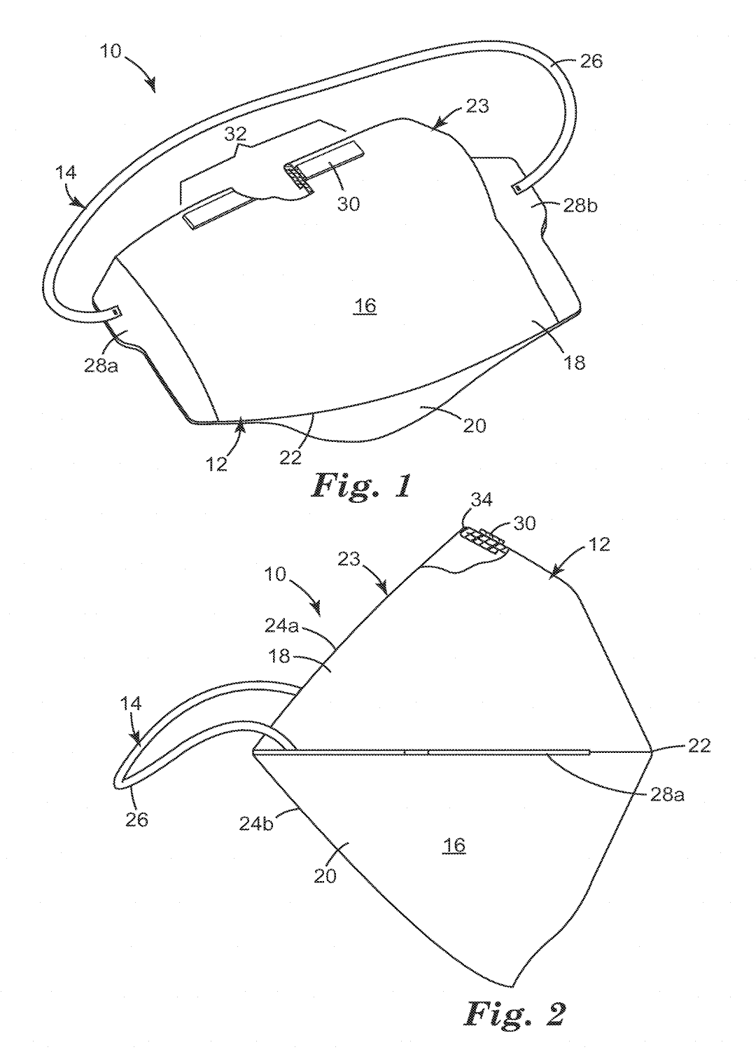

FIGS. 1 and 2 show an example of a flat fold filtering face-piece respirator 10 in an opened condition for placement on a wearer's face. The respirator 10 may be used to provide clean air for the wearer to breathe. As illustrated, the filtering face-piece respirator 10 includes a mask body 12 and a harness 14. The mask body 12 has a filtering structure 16 through which inhaled air must pass before entering the wearer's respiratory system. The filtering structure 16 removes contaminants from the ambient environment so that the wearer breathes clean air. The mask body 12 includes a top portion 18 and a bottom portion 20. The top portion 18 and the bottom portion 20 are separated by a line of demarcation 22 that extends lengthwise across the central portion of the mask body 12. The line of demarcation may be formed by a fold line, a bond line, a weld line, a seam line, or a combination of such lines. The mask body 12 also includes a perimeter 23 that includes an upper segment 24a and a lower segment 24b. The harness 14 has a strap 26 that is stapled to tabs 28a and 28b. A nose clip 30 may be placed on the mask body 12 on the top portion 18 on its outer surface or beneath a cover web. The nose clip 30 is placed in the nose region 32 along the upper segment 24a of the perimeter 23. As shown in the broken cross-section of the figure, the filtering structure 16 is folded over upon itself in the nose region 32 of the mask body 12. The folded filtering structure 16 has a deflection greater than 0.5 mm and has a recoverability of at least 40% when in the folded condition. More typically, the deflection is greater than 0.8 mm and the percent recovery is at least 50%. In a more preferred embodiment, the deflection is greater than 0.9 mm and the percent recovery is at least about 55%. The deflection and percent recovery of the folded mask body may be determined in accordance with the Deflection and Recoverability Test set forth below in the Example section.

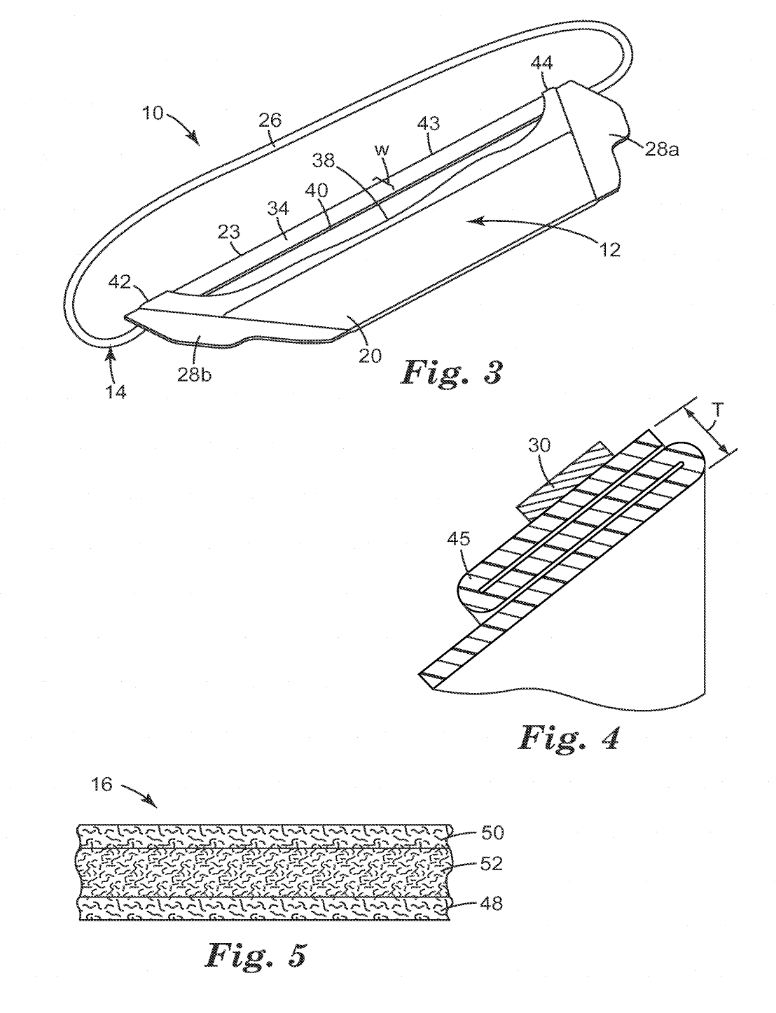

FIG. 3 shows the respiratory mask 10 in a folded condition suitable for storage. The bottom portion of the mask body 12 is broken away along line 38. The folded over portion of the perimeter 23 has peripheral edge 40 that extends in a generally straight line from a first side 42 of the mask body to a second side 44. A second parallel internal edge line 43 similarly extends in a straight manner from a first side 42 to a second side 44. The width W of the fold 34 is about 1 centimeter (cm) or more wide. More preferably, the fold has a width of 1 to 3 cm, more typically, 1.2 to 2.0 cm. The fold extends about 10 to 35 cm in the lengthwise dimension from side 42 to side 44, more typically about 15 to 30 cm.

FIG. 4 shows an alternative embodiment of a fold 44. In this embodiment, the fold 44 has an s-shape rather than the u-shape illustrated in FIGS. 1 and 2. An s-shape fold may be desired when additional cushioning is needed or desired in the nose region 32 or when the filtering structure itself is not so thick or lofty. If desired, the fold also could take on a w-shaped fold. As set forth in the Examples below, however, a u-shaped fold may be sufficient to achieve a snug fit in the nose region of the mask body to satisfy the present invention. The thickness (T) of the fold is generally about 1 to 5 mm, more typically about 1.5 to 3 mm.

FIG. 5 illustrates that the filtering structure 16 may include one or more layers of nonwoven fibrous material such as an inner cover web 48, an outer cover web 50, and a filtration layer 52. The inner and outer cover webs 48 and 50 may be provided to protect the filtration layer 52 and to preclude fibers in the filtration layer 52 from coming loose and entering the mask interior. During respirator use, air passes sequentially through layers 50, 52, and 48 before entering the mask interior. The air that is disposed within the interior gas space of the mask may then be inhaled by the wearer. When a wearer exhales, the air passes in the opposite direction, sequentially through layers 48, 52, and 50. Alternatively, an exhalation valve (not shown) may be provided on the mask body to allow exhaled air to be rapidly purged from the interior gas space to enter the exterior gas space without passing through filtering structure 16. Typically, the cover webs 48 and 50 are made from a selection of nonwoven materials that provide a comfortable feel, particularly on the side of the filtering structure that makes contact with the wearer's face. The construction of various filter layers and cover webs that may be used in conjunction with the filtering structure are described below in more detail. To improve wearer fit and comfort, an elastomeric face seal can be secured to the perimeter of the filtering structure 16. Such a face seal may extend radially inward to contact the wearer's face when the respirator is being donned. Examples of face seals are described in U.S. Pat. No. 6,568,392 to Bostock et al., U.S. Pat. No. 5,617,849 to Springett et al., and U.S. Pat. No. 4,600,002 to Maryyanek et al., and in Canadian Patent 1,296,487 to Yard.

The mask body that is used in connection with the present invention may take on a variety of different shapes and configurations. Although a filtering structure has been illustrated with multiple layers that include a filtration layer and two cover webs, the filtering structure may simply comprise a combination of filtration layers or a combination of filter layer(s) and cover web(s). For example, a pre-filter may be disposed upstream to a more refined and selective downstream filtration layer. Additionally, sorptive materials such as activated carbon may be disposed between the fibers and/or various layers that comprise the filtering structure, although such sorptive materials may be absent from the nose region so as to not compromise the desired snug fit. Further, separate particulate filtration layers may be used in conjunction with sorptive layers to provide filtration for both particulates and vapors. The filtering structure may include one or more stiffening layers that assist in providing a cup-shaped configuration during use. The filtering structure also could have one or more horizontal and/or vertical lines of demarcation that contribute to its structural integrity.

The filtering structure that is used in a mask body of the invention can be of a particle capture or gas and vapor type filter. The filtering structure also may be a barrier layer that prevents the transfer of liquid from one side of the filter layer to another to prevent, for instance, liquid aerosols or liquid splashes (e.g. blood) from penetrating the filter layer. Multiple layers of similar or dissimilar filter media may be used to construct the filtering structure of the invention as the application requires. Filters that may be beneficially employed in a layered mask body of the invention are generally low in pressure drop (for example, less than about 195 to 295 Pascals at a face velocity of 13.8 centimeters per second) to minimize the breathing work of the mask wearer. Filtration layers additionally are flexible and have sufficient shear strength so that they generally retain their structure under the expected use conditions. Examples of particle capture filters include one or more webs of fine inorganic fibers (such as fiberglass) or polymeric synthetic fibers. Synthetic fiber webs may include electret-charged polymeric microfibers that are produced from processes such as meltblowing. Polyolefin microfibers formed from polypropylene that has been electrically charged provide particular utility for particulate capture applications.

The filtration layer is typically chosen to achieve a desired filtering effect. The filtration layer generally will remove a high percentage of particles and/or or other contaminants from the gaseous stream that passes through it. For fibrous filter layers, the fibers selected depend upon the kind of substance to be filtered and, typically, are chosen so that they do not become bonded together during the manufacturing operation. As indicated, the filtration layer may come in a variety of shapes and forms and typically has a thickness of about 0.2 millimeters (mm) to 1 centimeter (cm), more typically about 0.3 mm to 0.5 cm, and it could be a generally planar web or it could be corrugated to provide an expanded surface area—see, for example, U.S. Pat. Nos. 5,804,295 and 5,656,368 to Braun et al. The filtration layer also may include multiple filtration layers joined together by an adhesive or any other means. Essentially any suitable material that is known (or later developed) for forming a filtering layer may be used as the filtering material. Webs of melt-blown fibers, such as those taught in Wente, Van A., Superfine Thermoplastic Fibers, 48 Indus. Engn. Chem., 1342 et seq. (1956), especially when in a persistent electrically charged (electret) form are especially useful (see, for example, U.S. Pat. No. 4,215,682 to Kubik et al.). These melt-blown fibers may be microfibers that have an effective fiber diameter less than about 20 micrometers (μm) (referred to as BMF for “blown microfiber”), typically about 1 to 12 μm. Effective fiber diameter may be determined according to Davies, C. N., The Separation Of Airborne Dust Particles, Institution Of Mechanical Engineers, London, Proceedings 1B, 1952. Particularly preferred are BMF webs that contain fibers formed from polypropylene, poly(4-methyl-1-pentene), and combinations thereof. Electrically charged fibrillated-film fibers as taught in van Turnhout, U.S. Pat. Re. 31,285, also may be suitable, as well as rosin-wool fibrous webs and webs of glass fibers or solution-blown, or electrostatically sprayed fibers, especially in microfiber form. Electric charge can be imparted to the fibers by contacting the fibers with water as disclosed in U.S. Pat. No. 6,824,718 to Eitzman et al., U.S. Pat. No. 6,783,574 to Angadjivand et al., U.S. Pat. No. 6,743,464 to Insley et al., U.S. Pat. Nos. 6,454,986 and 6,406,657 to Eitzman et al., and U.S. Pat. Nos. 6,375,886 and 5,496,507 to Angadjivand et al. Electric charge also may be imparted to the fibers by corona charging as disclosed in U.S. Pat. No. 4,588,537 to Klasse et al. or by tribocharging as disclosed in U.S. Pat. No. 4,798,850 to Brown. Also, additives can be included in the fibers to enhance the filtration performance of webs produced through the hydro-charging process (see U.S. Pat. No. 5,908,598 to Rousseau et al.). Fluorine atoms, in particular, can be disposed at the surface of the fibers in the filter layer to improve filtration performance in an oily mist environment—see U.S. Pat. Nos. 6,398,847 B1, 6,397,458 B1, and 6,409,806 B1 to Jones et al. Typical basis weights for electret BMF filtration layers are about 10 to 100 grams per square meter (g/m²). When electrically charged according to techniques described in, for example, the '507 Angadjivand et al. patent, and when including fluorine atoms as mentioned in the Jones et al. patents, the basis weight may be about 20 to 40 g/m² and about 10 to 30 g/m², respectively.

An inner cover web can be used to provide a smooth surface for contacting the wearer's face, and an outer cover web can be used to entrap loose fibers in the mask body or for aesthetic reasons. The cover web typically does not provide any substantial filtering benefits to the filtering structure, although it can act as a pre-filter when disposed on the exterior of (or upstream to) the filtration layer. To obtain a suitable degree of comfort, an inner cover web preferably has a comparatively low basis weight and is formed from comparatively fine fibers. More particularly, the cover web may be fashioned to have a basis weight of about 5 to 50 g/m² (typically 10 to 30 g/m²), and the fibers may be less than 3.5 denier (typically less than 2 denier, and more typically less than 1 denier but greater than 0.1 denier). Fibers used in the cover web often have an average fiber diameter of about 5 to 24 micrometers, typically of about 7 to 18 micrometers, and more typically of about 8 to 12 micrometers. The cover web material may have a degree of elasticity (typically, but not necessarily, 100 to 200% at break) and may be plastically deformable.

Suitable materials for the cover web may be blown microfiber (BMF) materials, particularly polyolefin BMF materials, for example polypropylene BMF materials (including polypropylene blends and also blends of polypropylene and polyethylene). A suitable process for producing BMF materials for a cover web is described in U.S. Pat. No. 4,013,816 to Sabee et al. The web may be formed by collecting the fibers on a smooth surface, typically a smooth-surfaced drum or a rotating collector—see U.S. Pat. No. 6,492,286 to Berrigan et al. Spun-bond fibers also may be used.

A typical cover web may be made from polypropylene or a polypropylene/polyolefin blend that contains 50 weight percent or more polypropylene. These materials have been found to offer high degrees of softness and comfort to the wearer and also, when the filter material is a polypropylene BMF material, to remain secured to the filter material without requiring an adhesive between the layers. Polyolefin materials that are suitable for use in a cover web may include, for example, a single polypropylene, blends of two polypropylenes, and blends of polypropylene and polyethylene, blends of polypropylene and poly(4-methyl-1-pentene), and/or blends of polypropylene and polybutylene. One example of a fiber for the cover web is a polypropylene BMF made from the polypropylene resin “Escorene 3505G” from Exxon Corporation, providing a basis weight of about 25 g/m² and having a fiber denier in the range 0.2 to 3.1 (with an average, measured over 100 fibers of about 0.8). Another suitable fiber is a polypropylene/polyethylene BMF (produced from a mixture comprising 85 percent of the resin “Escorene 3505G” and 15 percent of the ethylene/alpha-olefin copolymer “Exact 4023” also from Exxon Corporation) providing a basis weight of about 25 g/m² and having an average fiber denier of about 0.8. Suitable spunbond materials are available, under the trade designations “Corosoft Plus 20”, “Corosoft Classic 20” and “Corovin PP-S-14”, from Corovin GmbH of Peine, Germany, and a carded polypropylene/viscose material available, under the trade designation “370/15”, from J. W. Suominen O Y of Nakila, Finland.

Cover webs that are used in the invention preferably have very few fibers protruding from the web surface after processing and therefore have a smooth outer surface. Examples of cover webs that may be used in the present invention are disclosed, for example, in U.S. Pat. No. 6,041,782 to Angadjivand, U.S. Pat. No. 6,123,077 to Bostock et al., and WO 96/28216A to Bostock et al.

The strap(s) that are used in the harness may be made from a variety of materials, such as thermoset rubbers, thermoplastic elastomers, braided or knitted yarn/rubber combinations, inelastic braided components, and the like. The strap(s) may be made from an elastic material such as an elastic braided material. The strap preferably can be expanded to greater than twice its total length and be returned to its relaxed state. The strap also could possibly be increased to three or four times its relaxed state length and can be returned to its original condition without any damage thereto when the tensile forces are removed. The elastic limit thus is preferably not less than two, three, or four times the length of the strap when in its relaxed state. Typically, the strap(s) are about 20 to 30 cm long, 3 to 10 mm wide, and about 0.9 to 1.5 mm thick. The strap(s) may extend from the first tab to the second tab as a continuous strap or the strap may have a plurality of parts, which can be joined together by further fasteners or buckles. For example, the strap may have first and second parts that are joined together by a fastener that can be quickly uncoupled by the wearer when removing the mask body from the face. An example of a strap that may be used in connection with the present invention is shown in U.S. Pat. No. 6,332,465 to Xue et al. Examples of fastening or clasping mechanism that may be used to joint one or more parts of the strap together is shown, for example, in the following U.S. Pat. No. 6,062,221 to Brostrom et al., U.S. Pat. No. 5,237,986 to Seppala, and EP1,495,785A1 to Chien.

As indicated, an exhalation valve may be attached to the mask body to facilitate purging exhaled air from the interior gas space. The use of an exhalation valve may improve wearer comfort by rapidly removing the warm moist exhaled air from the mask interior. See, for example, U.S. Pat. Nos. 7,188,622, 7,028,689, and 7,013,895 to Martin et al.; 7,428,903, 7,311,104, 7,117,868, 6,854,463, 6,843,248, and 5,325,892 to Japuntich et al.; U.S. Pat. No. 6,883,518 to Mittelstadt et al.; and RE37,974 to Bowers. Essentially any exhalation valve that provides a suitable pressure drop and that can be properly secured to the mask body may be used in connection with the present invention to rapidly deliver exhaled air from the interior gas space to the exterior gas space.

### EXAMPLES

### Deflection and Recoverability Test

A test method was developed to measure the compressibility of various nose seal constructions in flat-fold filtering facepiece respirators. In order to understand the behavior of respirator nose seal constructions in way that is relevant, a compression force range that would be acceptable to respirator wearers was used. Pressure to the skin in excess of arterial capillary pressure can lead to pain and tissue damage, Lyder, C. H., Pressure Ulcer Prevention and Management, JAMA, 2003, 289:223-226. Normally, the arterial capillary pressure in human skin is between 2.7 and 5.4 kiloPascals (kPa). For the deflection test, samples were compressed with a maximum pressure of 2.5 kPa.

Samples of respirator seal constructions were tested with a TA.XTPlus™ texture analyser (Texture Technologies Corp, Scardsale, N.Y.). A test fixture constructed of aluminum, which had a flat rectangular working face measuring 51 mm long by 10 mm wide, was attached to the crosshead of the texture analyser. Samples of respirator nose regions constructions measuring approximately 70 mm long by 15 mm wide were placed between the working face of the fixture and a flat aluminum base plate. The sample was placed so that it was centered under the working face of the test fixture and was oriented to align the long side of the sample with the long side of the test fixture working face. Before analysis, the malleable noseclip was removed by slitting the outer layer of coverweb.

The texture analyser was controlled using Texture Exponent 32™ software (Texture Technologies Corp, Scarsdale, N.Y.). From a starting distance of 10 mm between the test fixture and base plate, the sample was compressed by the test fixture at a speed of 0.2 mm/s, until a compression force of 2.5 kPa was achieved. The crosshead was then returned to the starting position of 10 mm from the base plate at 0.2 mm/s. Using the Texture Exponent 32™ software, the deflection of the sample during the compression portion of the test between compression forces of 0.5 kPa and 2.5 kPa was determined. Energy was determined by calculating the area under the pressure/distance curve. The compression energy needed to deflect the sample during the compression portion of the test and the energy recovered during the return portion of the test were also determined. The % Recovery was determined by dividing the energy recovered by the compression energy and expressing the resulting fraction as a percentage.

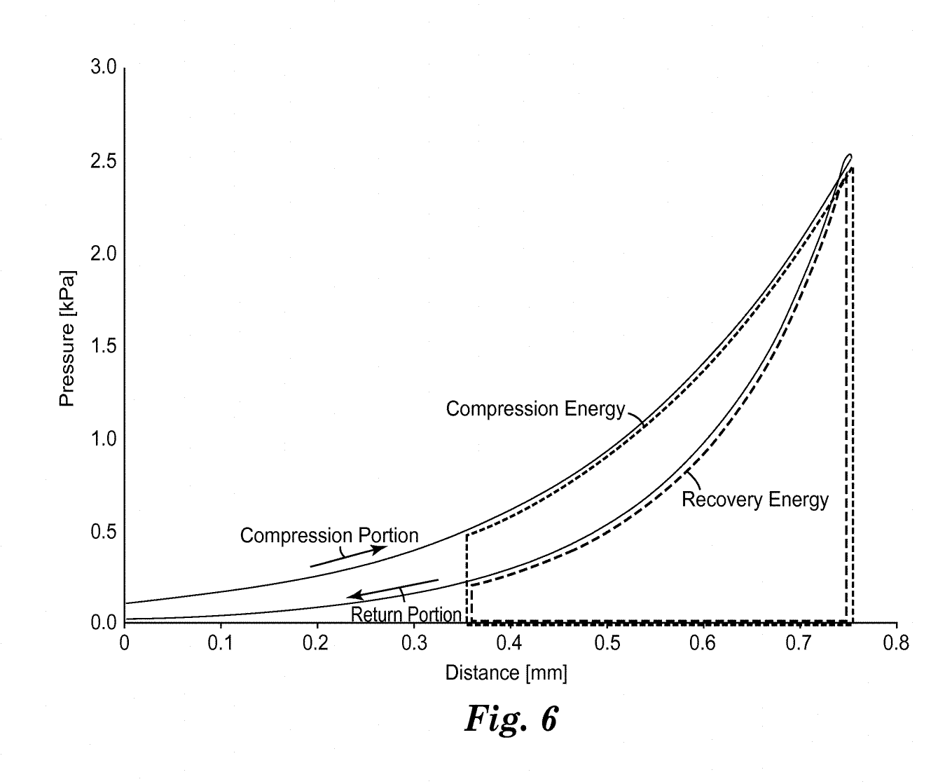

FIG. 6 illustrates a typical pressure/distance curve generated for the inventive samples under the Deflection and Recoverability Test. The curve shown is a plot of the pressure measurements obtained as the sample is compressed during the compression portion of the Test and as the sample recovers during the return portion of the Test. The area defined as the Compression Energy is obtained by calculating the area under the compression portion of the pressure/distance curve between the distance at which a pressure of 0.5 kPa is reached to the distance at which a pressure of 2.5 kPa is reached. The area defined as the Recovery Energy is obtained by calculating the area under the return portion of the pressure/distance curve between the distance at which a pressure of 0.5 kPa is reached on the compression portion of the curve and the distance at which a pressure of 2.5 kPa is reached on the pressure/distance curve.

### Comparative Sample 1

Five pleated flat-fold filtering facepiece respirators similar in design to respirator shown in FIGS. 1-3 were obtained, but the fold in the mask body of the nose region was absent. The filtering structure was composed of a layer of polypropylene meltblown electret filter medium disposed between two layers of polypropylene spunbond coverweb. The filter layer had a thickness of 1.2 mm, a basis weight of 68 g/m², and an effective fiber diameter (EFD) of 7 micrometers (μm). The coverweb used had a basis weight of 34 gsm and was obtained from ATEX Technologies, Inc. (Gainesville, Ga.). A sample for the Deflection and Recoverability Test was cut from the nose seal region of each respirator using a razor knife. Each cut sample was analyzed under the Deflection and Recoverability Test. Results are set forth below in Table 1.

### Example 1

Five pleated flat-fold filtering facepiece respirators similar in design to the respirator shown in FIGS. 1-3 were used. The filtering structure was composed of the same filtering and coverweb layers as Comparative Example 1. The structure of the nose sealing area of the respirators is shown in FIGS. 1-3. An extension of the respirator body laminate on the top sealing edge of the respirator was folded towards the inside of the respirator. Samples were tested under Deflection and Recoverability Test. Results are set forth below in Table 1.

### Example 2

Five pleated flat-fold filtering facepiece respirators similar in design to the respirator shown in the drawings were used. The filtering structure was the same as described in Comparative Example 1. The structure of the nose sealing area of the respirators was folded into a s-shaped configuration as shown in FIG. 4. Samples were tested under the Deflection and Recoverability Test. Results are set forth below in Table 1.

TABLE 1
Results of the Deflection and Recoverability Test

| | Sample | Deflection | % |
|---|---|---|---|
| Example | No. | [mm] | Recovery |
| Comparative Sample 1 | 1 | 0.264 | 67% |
| Comparative Sample 1 | 2 | 0.302 | 61% |
| Comparative Sample 1 | 3 | 0.500 | 55% |
| Comparative Sample 1 | 4 | 0.488 | 54% |
| Comparative Sample 1 | 5 | 0.296 | 61% |
| Example 1 | 1 | 0.916 | 57% |
| Example 1 | 2 | 0.872 | 59% |
| Example 1 | 3 | 0.892 | 55% |
| Example 1 | 4 | 1.003 | 56% |
| Example 1 | 5 | 1.067 | 56% |
| Example 2 | 1 | 0.999 | 58% |
| Example 2 | 2 | 1.083 | 54% |
| Example 2 | 3 | 0.954 | 54% |
| Example 2 | 4 | 0.956 | 53% |
| Example 2 | 5 | 1.013 | 55% |

The results of the Deflection and Recoverability Test demonstrate that the use of a folded mask body in accordance with the present invention (Examples 1 and 2, respectively) significantly increases the deflection compared to Comparative Sample 1. The % Recovery for Examples 1 and 2 and Comparative Sample 1 have similar % Recovery values, between 53% and 67%. The invention thus demonstrates a greater deflection at similar percent recoveries.

### Face Fit Performance of Comparative Sample 1 and Example 1

A face fit test was employed to determine the amount of leakage between a respirator user's face and the seal structure(s) of a tight-fitting respirator. The amount of face seal leakage between a respirator and a user's face can be quantified by measuring the concentration of a test aerosol (e.g. NaCl particles suspended in air) on the inside and outside of a respirator. A useful face fit test has been developed, which selectively detects particles of 60 nanometers (nm) or smaller. See U.S. Pat. No. 6,125,845 to Halvorson et al. A commercially available instrument suitable for use in the face fit test is the TSI PortaCount® Pro+(TSI Inc., Shoreview, Minn.). Another suitable instrument is the TSI PortaCount® Plus with N95-Companion™ (TSI Inc).

Ten samples each of Comparative Sample 1 and Example 1 were prepared for face fit testing on human subjects. Five samples of each type were made which had an opening width (distance between 42 and 44 in FIG. 3) of 218 mm. The other five samples of each type were made with an opening width of 238 mm. All respirator samples were provided with a harness that comprised two polyisoprene headbands of equal length attached to upper surface of laterally extending tabs (28a and 28b) using metal staples. Each sample included an annealed aluminum nose clip that was 1 mm thick, 5 mm wide, and 90 mm long. A sample probe fixture (TSI Inc) was attached to each sample so that the aerosol concentration inside the sample could be determined during the face fit test. Ten human subjects that had a range of facial lengths and facial widths were selected. The measured facial length and width correspond to menton-sellion length and bizygomatic breadth, respectively, as described by Z. Zhuang et al., New Respirator Fit Test Panels Representing the Current U.S. Civilian Workforce, Journal of Occupational and Environmental Medicine, 2007, 4:647-659. All subjects with a facial length less than 118.5 mm were tested using samples that had an opening width of 218 mm. All subjects having a facial length greater than 118.5 mm were tested with samples having an opening width of 238 mm.

Face fit tests were conducted in a test chamber that was approximately 2.5 m high by 2 m wide by 1.5 m deep and that was ventilated with filtered air. A NaCl aerosol where the particles had an approximate count median diameter of 50 nm was generated using a Model 9306 6-Jet Atomizer (TSI Inc.) containing 2% NaCl (weight to volume) in distilled water. The atomizer was adjusted so that a reading of between 1,500 particles/cc and 5,000 particles particles/cc could obtained with a fit test system composed of a PortaCount® Plus with N95-Companion™ in the “Count mode”.

For each fit test, the subjects donned the respirator sample, entered the chamber and attached the respirator to the fit test system via the sample probe and a hose. The subject was then asked to perform four exercises that are defined in US Code of Federal Regulations 29 CFR 1910.134, Appendix A, Part I.A.a4(b). During these exercises, particle concentration data was collected from the fit test system using a microcomputer. The data can be obtained without a microcomputer by running the fit test system in “Count mode” and recording the data manually from the fit test system readout. The specific exercises, their duration, and the data collection scheme are shown below in Table 2, the Face Fit Test Exercise and Data Collection Table. The start and end times are measured in seconds (s) after the exercise begins.

TABLE 2
Face Fit Test Exercise and Data Collection

| | | Fit Test | Sample | Sample |
|---|---|---|---|---|
| | Exercise | System Sample | Start | End |
| Exercise | Duration (s) | Source | Time (s) | Time (s) |
| Normal | 66 | Chamber | 6 | 21 |
| Breathing (1^{st}) | | Inside respirator | 36 | 66 |
| Up and Down | 66 | Chamber | 6 | 21 |
| Head | | Inside respirator | 36 | 66 |
| Movements | | | | |
| Grimace | 19 | No data | No data | No data |
| | | collected | collected | collected |
| Normal | 87 | Chamber | 6 | 21 |
| Breathing (2^{nd}) | | Inside respirator | 36 | 66 |
| | | Chamber | 72 | 87 |

A fit factor was calculated for each exercise except Grimace. Fit Factor is equal to the chamber aerosol concentration divided by the internal respirator aerosol concentration. For each exercise, the chamber aerosol concentration used was the mean of the chamber concentrations measured immediately before and after the concentration inside the respirator. An average fit factor for each subject with each sample respirator was obtained by calculating the harmonic mean of the three fit factors for the 1^{st} Normal Breathing, Up and Down Head Movements, and 2^{nd} Normal Breathing exercises. The harmonic mean can be obtained by computing the reciprocal of the arithmetic mean of the reciprocals of the individual exercise fit factors. The results are of the face fit tests conducted using samples of Comparative Sample 1 and Example 1 are shown below in Table 3:

TABLE 3
Face Fit Test Performance

| | Subject | Subject | Sample | Comparative | |
|---|---|---|---|---|---|
| | Face | Face | Opening | Sample 1 | Example 1 |
| | Length | Width | Width | Average Fit | Average Fit |
| Subject | (mm) | (mm) | (mm) | Factor | Factor |
| 1 | 102.5 | 130.5 | 218 | 404 | 906 |
| 2 | 106.0 | 133.0 | 218 | 21 | 428 |
| 3 | 111.5 | 126.0 | 218 | 54 | 303 |
| 4 | 117.5 | 135.5 | 218 | 42 | 3944 |
| 5 | 114.0 | 147.0 | 218 | 30 | 27 |
| 6 | 120.5 | 132.5 | 238 | 1258 | 4635 |
| 7 | 127.0 | 142.0 | 238 | 1408 | 151 |
| 8 | 128.0 | 157.0 | 238 | 1407 | 2208 |
| 9 | 129.0 | 140.0 | 238 | 79 | 3393 |
| 10 | 133.0 | 147.0 | 238 | 90 | 91 |

The fit factor for seven of the ten subjects was significantly higher for the inventive Example 1 when compared to Comparative Sample 1, showing a significant reduction in face seal leakage. In only two subjects (Subjects 5 and 10) were the fit factors found to be essentially equivalent between Comparative Sample 1 and Example 1. One subject out of the ten tested (Subject 7) had a lower fit factor with Example 1 than with Comparative Sample 1.

This invention may take on various modifications and alterations without departing from its spirit and scope. Accordingly, this invention is not limited to the above-described but is to be controlled by the limitations set forth in the following claims and any equivalents thereof.

This invention also may be suitably practiced in the absence of any element not specifically disclosed herein.

All patents and patent applications cited above, including those in the Background section, are incorporated by reference into this document in total. To the extent there is a conflict or discrepancy between the disclosure in such incorporated document and the above specification, the above specification will control.

1-15. (canceled)

16. A flat fold filtering face piece respirator that comprises:
a harness; and
a mask body that lacks a nose foam and that comprises a filtering structure that contains a cover web, and a filtration layer that contains electrically-charged microfibers, the filtering structure being folded over upon itself in a nose region of the mask body to create an overlapped portion having a width (W) that is 1 centimeter or more wide and that extends across the upper perimeter of the mask body in a generally straight line when the respirator is in a folded condition, the folded filtering structure having a deflection greater than 0.8 mm and having a recoverability of at least 50% when tested under the Deflection and Recoverability Test, wherein the folded filtering structure has a thickness (T) of at least 3 mm.

17. The respirator of claim 16, wherein the filtration layer is located between the first and second cover webs.

18. The respirator of claim 16, wherein the folded filtering structure has a thickness (T) of no greater than 5 mm.

19. The respirator of claim 16, wherein the fold has a width (W) of 1 to 3 cm.

20. The respirator of claim 19, wherein the fold has a width (W) of 1.2 to 2 cm.

21. The respirator of claim 16, wherein the fold extends in a generally straight line for 10 to 35 cm.

22. The respirator of claim 21, wherein the folded over portion of the mask body provides a peripheral edge that extends in a generally straight line parallel to a second internal edge.

23. The respirator of claim 16, wherein the fold extends in a generally straight line for 15 to 30 cm.

24. The respirator of claim 16, wherein the fold in cross section is U-shaped.

25. The respirator of claim 16, wherein the fold in cross section is S-shaped.

26. The respirator of claim 16, wherein the fold in cross section is W-shaped.

27. The respirator of claim 16, wherein the mask body comprises a nose clip in the nose region.

28. The respirator of claim 16, wherein the deflection is greater than 0.9 and the percent recovery is at least 55%.

29. The respirator of claim 16, wherein the filtration layer is located between the first and second cover webs.

30. The respirator of claim 29, wherein the nose clip is located beneath the second cover web.
